(19) United States
(12) Patent Application Publication
(10) Pub. No.: US 2026/0145590 A1
(43) Pub. Date: May 28, 2026

(54) SEAT RAIL

(71) Applicant: DAS CO., LTD, Gyeongju-si (KR)

(72) Inventors: Jin Gu PARK, Beomseo-eup (KR); Dong Yool KANG, Gyeongju-si (KR); Jong Soon LEE, Ulsan (KR)

(21) Appl. No.: 18/989,370

(22) Filed: Dec. 20, 2024

(30) Foreign Application Priority Data
Nov. 26, 2024 (KR) 10-2024-0170944

(51) Int. Cl. B60N 2/08; B60N 2/07

(52) U.S. Cl. CPC B60N 2/0806; B60N 2/0727

(57) ABSTRACT

The present disclosure relates to a seat rail which includes: a lower rail; an upper rail; and a locking unit, and the locking plate may include: a plate body; and a plurality of locking protrusions provided in the plate body, inserted into and fixed to the inserting hole, and selectively fastened to the locking hole, and the locking protrusion may include a support lock supporting one among the upper rail and the lower rail, and having one contact point supporting the upper rail or the lower rail, thereby minimizing a clearance and a flow of the seat rail in a forward-rearward direction.

### CROSS REFERENCE TO RELATED APPLICATION

The present application claims priority to Korea Patent Application 10-2024-0170944, the entire contents of which is incorporated herein for all purposes by this reference.

### FIELD

The present disclosure relates to a seat rail, more particularly, to a seat rail preventing a clearance and a flow between a lower rail and an upper rail.

### BACKGROUND

In general, seats of a driver seat and a passenger seat are provided such that positions thereof in a forward-rearward direction based on a vehicle traveling direction can be adjusted. To this end, the seat is fixed to a bottom surface of the vehicle through a seat rail.

The seat rail consists of a lower rail fixed to the bottom surface of the vehicle body and an upper rail slidingly movable with respect to the lower rail and allowing a cushion frame of the seat to be mounted thereon. A locking device of a seat rail is provided between the upper rail and the lower rail, thereby the fixed state can be maintained after adjusting a forward-rearward position of the seat.

The locking method of the conventional seat rail is provided in a manner that a locking plate of a locking unit is engaged with the upper rail and a lower rail so as to fix the seat at a position set by the passenger, and the seat does not leave the fixed position when a forward-rearward load is applied thereto because of a collision.

In addition, the locking plate includes a plurality of locks and each of the locks is fastened to the lower rail and the upper rail both, and is inserted into a locking hole of the upper rail and the lower rail to be locked.

However, the conventional seat rail has a problem in that the plurality of locks of the locking plate are locked randomly to the upper rail and the upper rail and a clearance and a flow occur due to part dispersion such as a manufacturing tolerance and an assembly tolerance.

In more detail, when a portion of the locking plate fitted to the lower rail and the upper rail is referred to as a contact point, there is a problem in that a lock among the plurality of locks of the locking plate having the contact point is set randomly.

For example, when the plurality of locking plates is fitted to the lower rail only, the upper rail has a flow in a forward-rearward direction, and when the plurality of locking plates is fitted to the upper rail only, the lower rail has a flow in a forward-rearward direction.

As another example, when the plurality of locking plates is fitted to the lower rail only in a forward-rearward direction, but is fitted to the upper rail in a forward direction only, a clearance occurs in a rearward direction and a flow is generated between the upper rail and the lower rail.

Similarly, when the plurality of locking plate is fitted to the upper rail only in a forward-rearward direction, but is fitted to the lower rail in a forward direction or a rearward direction only, a clearance occurs and a flow is generated between the upper rail and the lower rail.

As another example, when a lock having a contact point on the locking plate is disposed to lean to one side in a left-right direction, there is a problem in that a flow in which the locking plate rotates is generated and a slip occurs.

In particular, there is a problem in that the moment is generated in the locking plate due to a support force supporting the lower rail and the upper rail and a gap between the lower rail and the upper rail, and the locking plate rotates about a contact point of the lower rail.

Finally, a locking structure having a contact point set randomly between the lower rail and the upper rail is needed so as to minimize a clearance and a rotational flow in a state in which the locking plate is fastened to the lower rail and the upper rail.

### PRIOR ART LITERATURE

### Patent Literature

(Patent Literature 001) Korea Patent No. 10-2446336

### SUMMARY

Accordingly, the present disclosure is conceived to solve the above-described problem, and an object of the present disclosure is to provide a seat rail which minimizes a clearance, a flow and a rattle in a forward-rearward direction generated during locking.

In more detail, an object of the present disclosure is to provide a seat rail which supports the lower rail and the upper rail only at a necessary contact point when the locking plate is locked to the lower rail and the upper rail, even if part dispersion such as the manufacturing tolerance and assembly tolerance is generated.

In addition, an object of the present disclosure is to provide a seat rail which includes four locks including two locks supporting the lower rail in a forward-rearward direction, and two locks supporting the upper rail in a forward-rearward direction, and has another lock, except the four locks, spaced apart from the lower rail and the upper rail.

In addition, an object of the present disclosure is to provide a seat rail which prevents a rotation and a flow of the locking plate as the four locks supporting the lower rail and the upper rail in a forward-rearward direction, respectively, are dispersely disposed.

In particular, an object of the present disclosure is to provide a seat rail capable of maintaining only four necessary contact points because a remaining portion, except a portion having the contact point of the lock, secures a sufficient gap with the lower rail and the upper rail, and maintaining four contact points despite deformation in the upper rail and the lower rail due to an external load and impact.

One embodiment is a seat rail, including: a lower rail installed on a bottom surface of a vehicle body and having a plurality of locking holes; an upper rail fastened to a cushion frame of a seat, configured to move along the lower rail and having a plurality of inserting holes; and a locking unit having a locking plate provided in the upper rail and selectively fastened to the lower rail, and configured to fix a position of the upper rail with respect to the lower rail, and the locking plate may include: a plate body; and a plurality of locking protrusions provided in the plate body, inserted into and fixed to the inserting hole, and selectively fastened to the locking hole, and the locking protrusion may include a support lock supporting one among the upper rail and the lower rail, and having one contact point supporting the upper rail or the lower rail.

The support lock may be in contact with one among an inner forward surface and an inner rearward surface of the inserting hole and may be spaced apart from another one thereamong, or, may be in contact with one among an inner forward surface and an inner rearward surface of the locking hole and may be spaced apart from another one thereamong.

The support lock may include a protrusion stepped and protruding from one surface on which the contact point is provided, and supporting the upper rail or the lower rail.

A width of the locking hole in a forward-rearward direction may be smaller than a width of the inserting hole in a forward-rearward direction, and the support lock may be spaced apart forward or rearward from a center of the locking hole by as much as a pre-determined gap and may support the lower rail.

A width of the inserting hole in a forward-rearward direction may be smaller than a width of the locking hole in a forward-rearward direction, and
the support lock may be spaced apart forward or rearward from a center of the inserting hole by as much as a pre-determined gap and may support the upper rail.

The support lock may include; a first lock supported on an inner forward surface of the inserting hole; a second lock supported on inner reward surface of the inserting hole; a third lock supported on an inner forward surface of the locking hole; and a fourth lock supported on inner reward surface of the locking hole.

In the locking plate, when the first lock is disposed on one side in a left-right direction of the plate body, the second lock may be disposed on another side in a left-right direction of the plate body, and when the third lock is disposed on one side in a left-right direction of the plate body, the fourth lock may be disposed on another side in a left-right direction of the plate body.

In the locking plate, the first lock and the fourth lock may be disposed on one side in a left-right direction of the plate body, and the second lock and the third lock may be disposed on another side in a left-right direction of the plate body.

In the locking plate, the first lock and the second lock may be disposed on a same line, and the third lock and the fourth lock may be disposed on a same line.

The locking protrusion may further include: a plurality of spacing locks inserted into the inserting hole and the locking hole and inserted thereinto with a gap in a forward-rearward direction.

The upper rail may have the inserting hole opened downward and may be provided such that an inner forward surface and an inner rearward surface thereof are inclined, and a width thereof in a forward-rearward direction becomes greater toward a lower side, and the lower rail may have the locking hole opened downward and may be provided such that an inner forward surface and an inner rearward surface thereof are inclined, and a width thereof in a forward-rearward direction becomes greater toward a lower side.

There are one or more effects as below according to the seat rail of the present disclosure.

First, as described above, according to the seat rail according to the present disclosure, there is an effect of minimizing a clearance, a flow, and a rattle in a forward-rearward direction generated during locking.

In more detail, when the locking plate is locked to the lower rail and the upper rail, even if part dispersion such as a manufacturing tolerance and an assembly tolerance is caused or the upper rail is deformed by the external load and impact, there is an effect that the locking plate can support the lower rail and the upper rail only at necessary contact points.

In addition, there is an effect that random generation of the contact point of the locking plate can be prevented because the locking plate has four locks supporting the upper rail in a forward-rearward direction and supporting the lower rail in a forward-rearward direction, respectively, and another lock except the four locks is spaced apart from the lower rail and the upper rail.

Moreover, there is an effect of preventing a rotation and a flow of the locking plate because four locks supporting the lower rail and the upper rail in a forward-rearward direction, respectively, are disposed dispersely.

Further, there is an effect that the locking plate can maintain only four necessary contact points because a remaining portion except a portion having the contact point of the lock secures a sufficient gap with the lower rail and the upper rail, and can maintain four contact points despite deformation of the upper rail and the lower rail due to the external load and impact.

### BRIEF DESCRIPTION OF THE DRAWINGS

FIG. 1 is a perspective view of a seat rail according to an embodiment of the present disclosure.

FIGS. 2 to 4 are exploded perspective view of a seat rail according to an embodiment of the present disclosure.

FIG. 5 is an elevational view of a seat rail according to an embodiment of the present disclosure.

FIG. 6 is a cross-sectional view of a seat rail according to an embodiment of the present disclosure.

FIG. 7 is an enlarged view of a fastening portion of a locking plate in FIG. 6 according to an embodiment of the present disclosure.

FIGS. 8a to 8d are enlarged views of a contact point of FIG. 7 according to an embodiment of the present disclosure.

FIGS. 9a, 9b, 10a and 10b are cross-sectional views for describing a contact point of a seat rail according to an embodiment of the present disclosure.

### DETAILED DESCRIPTION

Hereinafter, exemplary embodiments will be fully described with reference to the accompanying drawings.

While the present disclosure is susceptible to various modifications and alternative forms, specific embodiments are shown by way of example in the drawings and described in detail. It should be understood, however, that the description is not intended to limit the present disclosure to the specific embodiments, but, on the contrary, the present disclosure is to cover all modifications, equivalents, and alternatives that fall within the spirit and scope of the present disclosure.

It will be understood that when the terms “first” and “second” are used herein to describe various components, these components should not be limited by these terms. The above terms are used only to distinguish one component from another. For example, a first component may be referred to as a second component and vice versa without departing from the scope of the present disclosure.

The term “and/or” includes any and all combinations of one or more of the associated listed items.

It will be understood that when a component is referred to as being “connected” or “coupled” to another component, the two components may be directly connected or coupled to each other, or intervening components may be present between the two components. It will be understood that when a component is referred to as being “directly connected or coupled”, no intervening components are present between the two components.

The terminology used herein is for the purpose of describing particular embodiments only and is not intended to be limiting of the present disclosure. As used herein, the singular forms are intended to include the plural forms as well, unless the context clearly indicates otherwise.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, the following exemplary embodiments of the present disclosure are provided to those skilled in the art in order to describe the present disclosure more completely. Accordingly, shapes and sizes of elements shown in the drawings may be exaggerated for clarity.

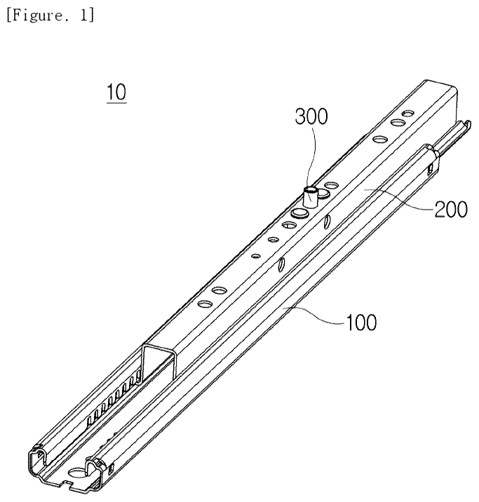

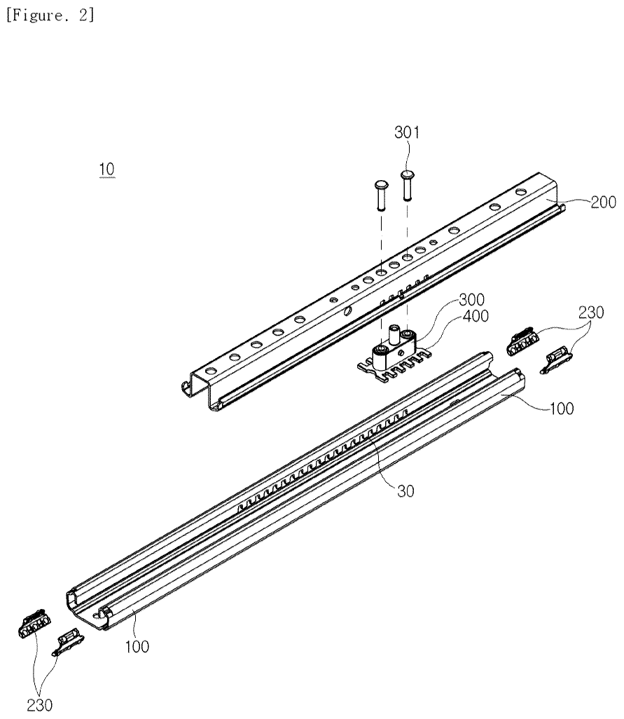

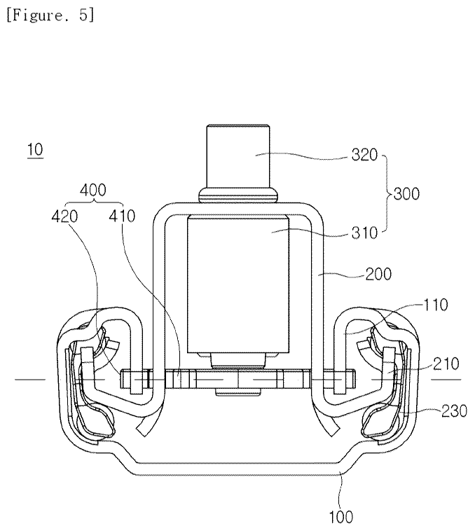

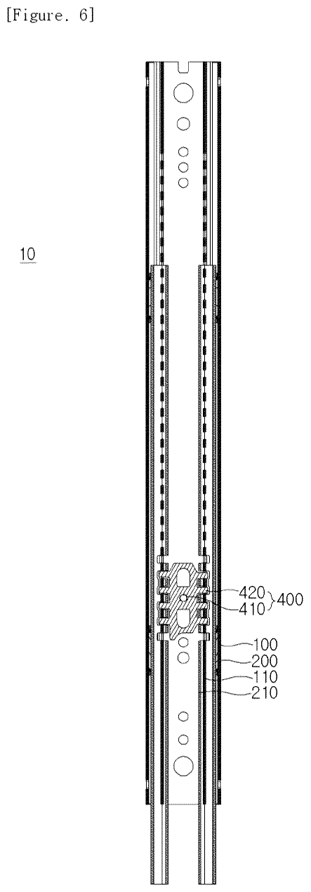

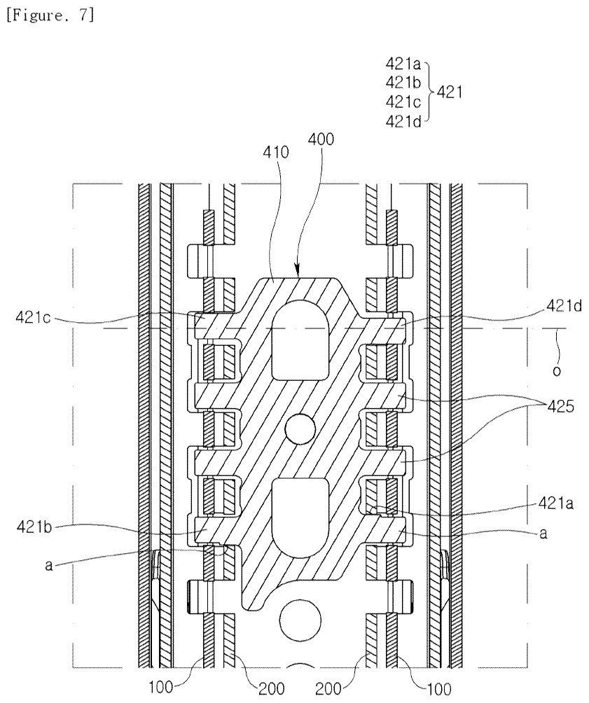

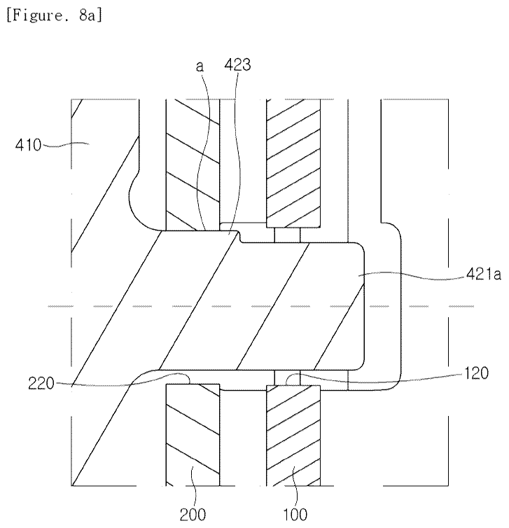

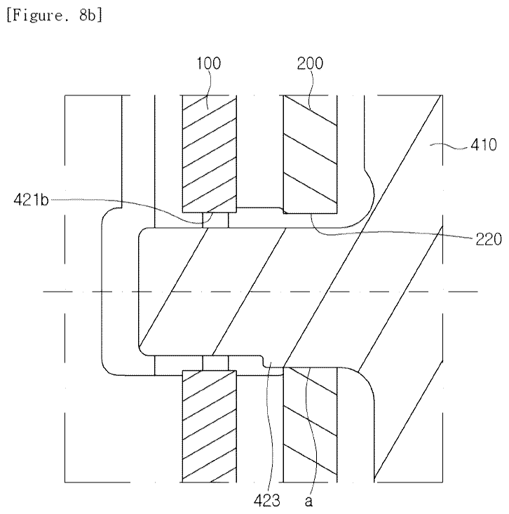

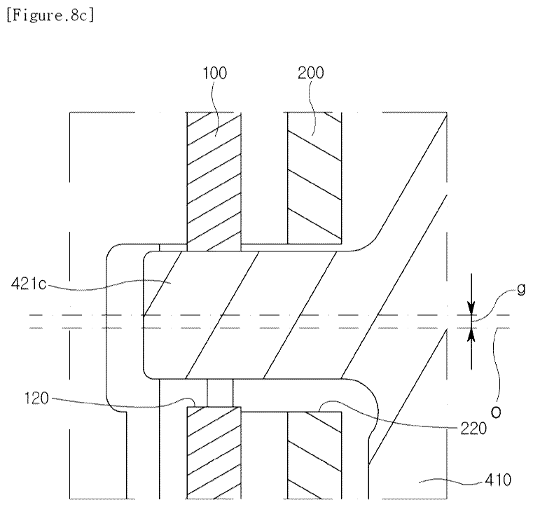

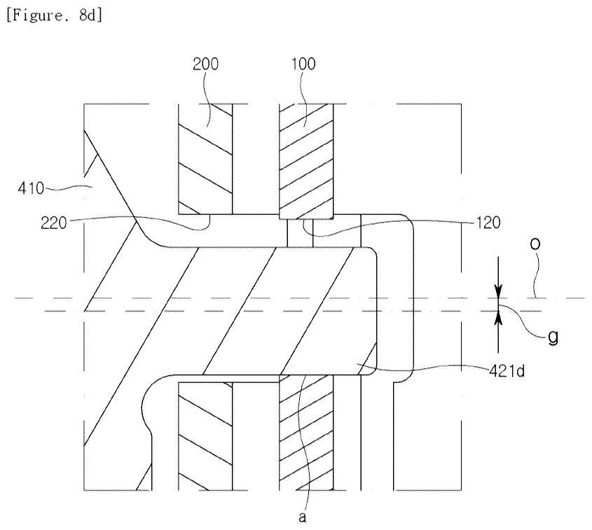

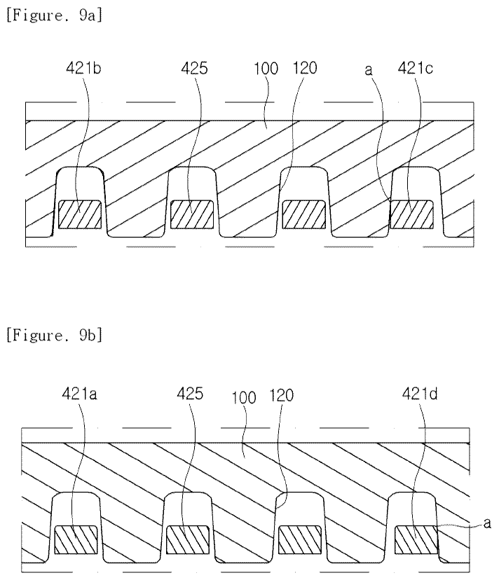

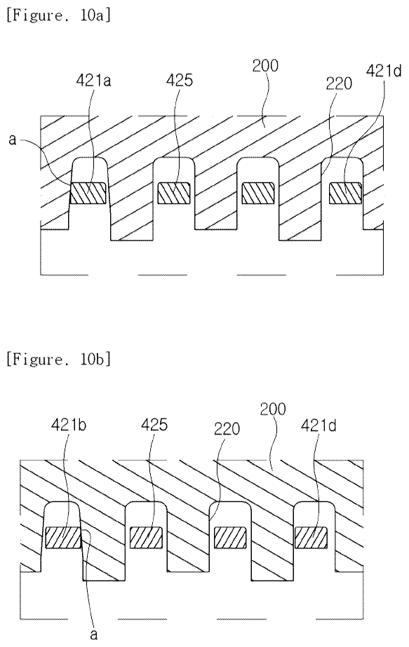

FIG. 1 is a perspective view of a seat rail according to an embodiment of the present disclosure, FIGS. 2 to 4 are exploded perspective view of a seat rail according to an embodiment of the present disclosure, FIG. 5 is an elevational view of a seat rail according to an embodiment of the present disclosure, FIG. 6 is a cross-sectional view of a seat rail according to an embodiment of the present disclosure, FIG. 7 is an enlarged view of a fastening portion of a locking plate in FIG. 6 according to an embodiment of the present disclosure, FIGS. 8a to 8d are enlarged views of a contact point of FIG. 7 according to an embodiment of the present disclosure, and FIGS. 9a, 9b, 10a and 10b are cross-sectional views for describing a contact point of a seat rail according to an embodiment of the present disclosure.

A seat rail 10 according to the present disclosure includes: a lower rail 100 installed on a bottom surface of a vehicle body and having a plurality of locking holes; an upper rail 200 fastened to a cushion frame of a seat, configured to move along the lower rail 100 and having a plurality of inserting holes 220; and a locking unit 400 having a locking plate 400 provided in the upper rail and selectively fastened to the lower rail 100, and configured to fix a position of the upper rail 200 with respect to the lower rail 100. The locking plate 400 includes: a plate body 410; and a plurality of locking protrusions 420 provided in the plate body 410, inserted into and fixed to the inserting hole 220, and selectively fastened to the locking hole 120, and the locking protrusion 420 includes a support lock 421 supporting one among the upper rail 200 and the lower rail 100, and having one contact point (a) supporting the upper rail 200 or the lower rail 100.

Referring to FIGS. 1 to 9, the seat rail 10 according to an embodiment of the present disclosure includes the lower rail on which the locking hole 120 formed is formed, the upper rail 200 on which the inserting hole 220 is formed, and the locking unit 300. The lower rail 100 is installed on a bottom surface of the vehicle body and the upper rail 200 moves along the lower rail 100.

More particularly, the lower rail 100 is fixed to the indoor bottom surface of the vehicle and the upper rail 200 is fastened to the cushion frame of the seat. The upper rail 200 is installed to be movable in a forward-rearward direction along a longitudinal direction of the lower rail 100 through a slidable coupling to the lower rail 100. That is, the coupling between the upper rail 200 and the lower rail 100 has a structure in which the upper rail 200 can move in a longitudinal direction with respect to the lower rail 100.

The lower rail 100 has a U-shaped cross-section, and at both ends thereof, lower flanges 110 bent downward are formed. The upper rail 200 has a reversed U-shape and at both ends thereof, lower flanges 210 bent upward are formed. Therefore, when the upper rail 200 is slidably fastened to the lower rail 100, an arrangement in which both ends of the lower rail 100, the lower flange 110, both ends of the upper rail 200, and the upper flange 210 cross and overlap each other is formed.

In addition, both ends of the lower rail 100, and the lower flange 110 are disposed to cover the upper flange 210, and both ends of the upper rail 200, and the upper flange 210 are disposed to cover the lower flange 110.

Further, between the lower rail 100 and the upper rail 200, a bearing 230 is disposed. The bearing 230 is slidably installed in the upper rail 200, and may roll in a state of being in contact with an inner side surface of the lower rail 100 and the lower flange 110. The bearing 230 is installed in the upper flange 210, and supports a forward-rearward movement of the upper rail 200 while rolling along the lower rail 100. Here, the forward-rearward direction may be a forward-rearward direction of the vehicle, and may mean a longitudinal direction of the lower rail 100.

The lower rail 100 includes a plurality of locking holes 120 into which the locking protrusions 420 of the locking plate 400 to be described below are inserted.

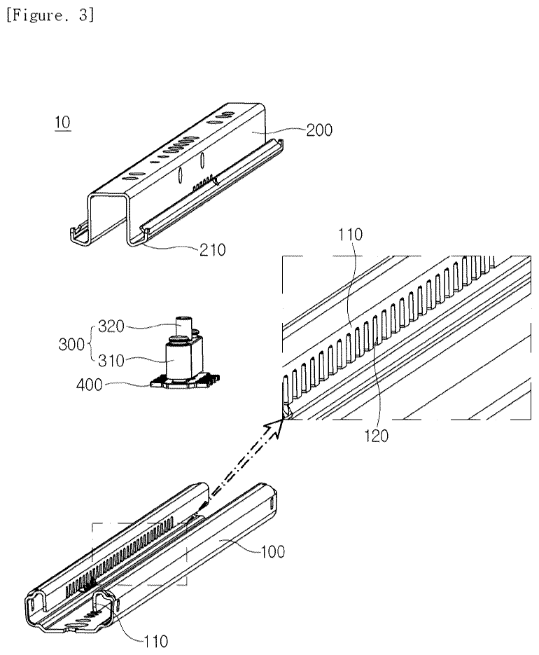

Referring to FIG. 3, the locking holes 120 are provided in the lower flange 110, and may be spaced apart from each other at an equal interval in a forward-rearward direction. The locking holes 120 may be spaced apart from each other at an equal interval in a forward-rearward direction in a section in which a length in a forward-rearward direction between the lower rail 100 and the upper rail 200 is adjusted. In addition, the locking holes 120 have the same shape and manufacture of the lower rail 100 is easy.

The locking hole 120 is formed to be open downward, and the locking protrusion 420 is inserted into an inside thereof through an opening. The locking hole 120 has an inner forward surface and an inner rearward surface disposed to face each other, and the inner forward surface and the inner rearward surface may be formed such that the inner forward surface and the inner rearward surface are inclined and a width thereof in a forward-rearward direction becomes greater toward a lower side. Therefore, the locking protrusion 420 can be easily inserted into the locking hole 120.

In addition, the locking protrusion 420 is inserted into an inside of the locking hole 120 when the locking unit 300 is locked, and the locking protrusion 420 is completely separated from the locking hole 120 when the locking unit 300 is unlocked. That is, when the locking unit 300 is unlocked, the locking protrusion 420 is separated from the lower rail 100 and is spaced apart from an end of the lower flange 110.

The upper rail 200 has a plurality of inserting holes 220 into which the locking protrusions 420 of the locking plate 400 are inserted.

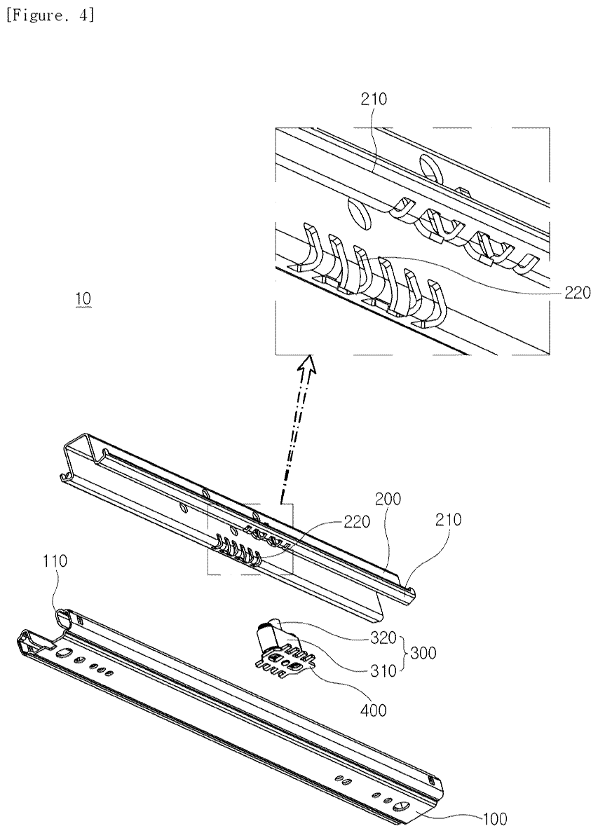

Referring to FIG. 4, the inserting holes 220 are provided in the upper flange 210, and are disposed to be spaced apart from each other at an equal interval in a forward-rearward direction. The inserting hole 220 may be disposed in a quantity equal to or more than a quantity of the locking protrusions 420 disposed on one side in a left-right direction of the locking plate 400. In addition, the inserting holes 220 are provided to have the same shape and manufacture of the upper rail 200 is easy. The plurality of inserting holes 220 may be formed in a central area of the upper rail 200.

However, in order to secure a contact point (a) of the locking protrusion 420, a width of the inserting hole 220 in a forward-rearward direction may be greater or smaller than a width of the locking hole 120 in a forward-rearward direction. For example, as illustrated in the drawing, the width of the inserting hole 220 in a forward-rearward direction may be greater than a width of the locking hole 120 in a forward-rearward direction. In addition, though not illustrated, the width of the inserting hole 220 in a forward-rearward direction may be smaller than the width of the locking hole 120 in a forward-rearward direction.

The inserting hole 220 is formed to be open downward, and the locking protrusion 420 may be inserted into an inside thereof through the opening. The inserting hole 220 has an inner forward surface and an inner rearward surface disposed to face each other, and the inner forward surface and the inner rearward surface may be formed such that the inner forward surface and the inner rearward surface are inclined and a width thereof in a forward-rearward direction becomes greater toward a lower side. The inserting hole 220 may be provided throughout both ends of the upper rail 200 and the upper flange 210.

The locking unit 300 is provided in the upper rail 200, is selectively fastened to the lower rail 100, and is configured to fix a position of the upper rail 200 with respect to the lower rail 100. In more detail, the locking unit 300 may include a lock pin guide 310, a lock pin 320, and the locking plate 400.

The lock pin guide 310 is formed to have a block shape and may be fixedly installed in the upper rail 200 through a fastening member 301. In addition, the lock pin guide 310 may include a lock pin inserting hole (not illustrated) allowing the lock pin 320 to be inserted thereinto to be able to ascend and descend.

The lock pin 320 is provided to be able to ascend and descend according to manipulation of a track lever (not illustrated) by the user. The lock pin 320 is provided to be able to ascend and descend in the lock pin guide 310 and a lower end thereof is fixed to the locking plate 400 and may ascend and descend together with the locking plate 400 when it ascends and descends.

The locking plate 400 is fixed to the lock pin 320 and may ascend and descend together with the lock pin 320, and when the locking plate 400 ascends, the locking plate 400 is fastened to the locking hole 120, and when the locking plate 400 descends, the locking plate 400 is unfastened from the locking hole 120 and is separated from the lower rail 100. That is, the locking plate 400 is fastened to the upper rail 200 and may move in a forward-rearward direction together with the upper rail 200, and is inserted into the inserting hole 220 and the locking hole 120 to fix a position of the upper rail 200 to the lower rail 100. The locking plate 400 is engaged with the inserting hole 220 and the locking hole 120, fixes the upper rail 200 at a position set by the passenger, and secures the upper rail 200 to not to leave the fixed position when a load in a forward-rearward direction is applied thereto due to the vehicle collision.

In more detail, the locking plate 400 may include the plate body 410, and a plurality of locking protrusions 420.

The plate body 410 has a plate shape, and includes a plurality of locking protrusions 420 in each of a left end and a right end. The plate body 410 is provided such that a quantify of the locking protrusions in the left end and a quantify of the locking protrusions in the right end are the same, and each of the locking protrusions in the left end is disposed at a position corresponding to each of the locking protrusions in the right end, and the interval at which the locking protrusions are spaced apart may be the same.

The locking protrusion 420 is inserted into the locking hole 120 of the lower rail 100 and the inserting hole 220 of the upper rail 100. The locking protrusion 420 is provided in the plate body 410 and is fixedly inserted into the inserting hole 220, and may be selectively fastened to the locking hole 120.

The seat rail 10 according to the present disclosure is characterized in that it has four contact points (1) supporting the upper rail 200 or the lower rail 100 in the locking plate 400, and one contact point (a) is provided to each of the locks.

Referring to FIGS. 7 to 9, the locking protrusion 420 of the locking plate 400 may include a support lock 421 supporting one among the upper rail 200 and the lower rail 100, and a spacing lock 425 spaced apart from the upper rail 200 and the lower rail 100. The locking protrusion 420 is provided in an even number, and may consist of four support locks 421 and a plurality of spacing locks 425. Alternatively, the locking protrusion 420 may consist of four support locks 421 only.

The spacing lock 425 is inserted into the inserting hole 220 and the locking hole 120, with a gap interposed therebetween in a forward-rearward direction so as not to support the upper rail 200 and the lower rail 100. The spacing lock 425 normally does not support the upper rail 200 and the lower rail 100, and when the vehicle collision occurs, the spacing lock 425 maintains a locking state between the lower rail 100 and the upper rail 200 so as to secure safety of the passenger.

The spacing lock 425 is normally inserted into the inserting hole 220 and the locking hole 120, and is spaced apart from an inner forward surface and an inner rearward surface of each of them, therefore, only four contact points (a) can be provided in the locking plate 400. Therefore, even if the assembly variation occurs, only four contact points (a) of the locking plate 400 can support the upper rail 200 or the lower rail 100.

However, the spacing lock 425 and the supporting lock 421 may be provided to have the same shape, and the support lock 421 may have a stepped shape or may lean to the forward side or the rearward side.

The locking protrusion 420 may support one among the upper rail 200 and the lower rail 100 and has one contact point (1) supporting the upper rail 200 or the lower rail 100. That is, the locking protrusion 420 may be provided to support the upper rail 200 on a forward side or a rearward side, or to support the lower rail 100 on a forward side or a rearward side. In addition, four locking protrusions 420 are provided in the plate body 410, and the contact point (a) may be provided in each of the locking protrusion 420 at each different position.

The support lock 421 may be in contact with one among the inner forward surface and the inner rearward surface of the inserting hole 220, and may be spaced apart another one thereamong. Alternatively, the support lock 421 may be in contact with one among the inner forward surface and the inner rearward surface of the locking hole 120, and may be spaced apart another one thereamong.

That is, when one side surface of the support lock 421 in a forward-rearward direction supports the upper rail 200 or the lower rail 100, another side surface thereof in a forward-rearward direction is spaced apart from the upper rail 200 or the lower rail 100. Therefore, the support lock 421 is configured such that the support lock 421 has one contact point (a) and does not have an unnecessary contact point (a).

To this end, the support lock 421 has a stepped shape on one side surface or another side surface in a forward-rearward direction, or may lean to the forward side or the rearward side.

First, the support lock 421 may include a protrusion 423 stepped and protruding from one surface on which the contact point (a) is provided and supporting the upper rail 200 or the lower rail 100. Therefore, when the support lock 421 supports the upper rail 200 or the lower rail 100 in a forward-rearward direction, the protrusion 423 stepped from one surface supports the upper rail 200 or the lower rail 100. For example, when the support lock 421 supports the upper rail 200, the protrusion 423 may support the upper rail 200 and be spaced apart from the lower rail 100.

In addition, the support lock 421 may lean to the forward side or the rearward side by as much as a predetermined gap (g) from a reference position (o). That is, when a position at which the locking protrusion 420 is spaced apart from each other in the locking protrusion 420 is referred to as a reference position (o), the support lock 421 may be disposed at a position which is moved to the forward side or the rearward side by as much as the predetermined gap (g) from the reference position (o).

For example, as illustrated in the drawings, when a width of the locking hole 120 in a forward-rearward direction is smaller than a width of the inserting hole 220 in a forward-rearward direction, because the support lock 421 is disposed at a position which is spaced apart in a forward direction or a rearward direction by as much as the predetermined gap (g) from the center of the locking hole 120, the support lock 421 can support the lower rail 100.

As another example, though not illustrated in the drawings, when a width of the inserting hole 220 in a forward-rearward direction is smaller than a width of the locking hole 120 in a forward-rearward direction, because the support lock 421 is disposed at a position which is spaced apart in a forward direction or a rearward direction by as much as the predetermined gap (g) from the center of inserting hole 220, the support lock 421 can support the upper rail 200.

Meanwhile, the support lock 421 may consist of a first lock 421a supported on an inner forward surface of the inserting hole 220, a second lock 421b supported on an inner rearward surface of the inserting hole 220, a third lock 421c supported on an inner forward surface of the locking hole 120, and a fourth lock 421d supported on an inner rearward surface of the locking hole 120.

The first lock 421a and the second lock 421b are configured to support the upper rail on a forward side and a rearward side, respectively, and have a stepped shape to be spaced apart from the lower rail 100 while supporting the upper rail 200.

Referring to FIGS. 7, 8a and 10a, the first lock 421a has the protrusion 423 which is part of the forward surface thereof protruding toward the upper rail 200, and as the protrusion 423 supports the inner forward surface of the inserting hole 220, the first lock 421a supports the upper rail 200 on the forward side.

Referring to FIGS. 7, 8b and 10b, the second lock 421b has the protrusion 423 which is part of the rearward surface thereof protruding toward the upper rail 200, and as the protrusion 423 supports the inner rearward surface of the inserting hole 220, the second lock 421b supports the upper rail 200 on the rearward side.

A width of the protrusion 423 in a forward-rearward direction may be smaller than a width of the inserting hole 220 in a forward-rearward direction, and may be greater than a width of the locking protrusion 420 in a forward-rearward direction. The first lock 421a and the second lock 421b include the protrusion 423 so as to support the upper rail 200, and an end of the support lock 421 is smaller than a thickness of the protrusion 423 in a forward-rearward direction, therefore, manufacture of the support lock 421 is easy and high manufacture quality is provided.

In addition, the third lock 421c and the fourth lock 421d supporting the lower rail 100 on a forward side and a rearward side, respectively, are disposed to lean to the forward side or the rearward side from the reference position (o), and thus, are provided to support the lower rail 100.

At this instance, as the third lock 421c and the fourth lock 421d are disposed to lean to the forward side or the rearward side, the width of the locking hole 120 in the forward-rearward direction is smaller than the width of the inserting hole 220 in the forward-rearward direction so that each of the third lock 421c and the fourth lock 421d supports the lower rail 100 in the forward direction and the rearward direction. Therefore, the third lock 421c and the fourth lock 421d may support the lower rail 100 having a relatively smaller width in a forward-rearward direction. Further, the third lock 421c and the fourth lock 421d may be spaced apart further from the upper rail 200 in the forward direction and the rearward direction.

Referring to FIGS. 7, 8c and 9a, the third lock 421c is disposed to lean to the forward side by as much as a certain gap (g), and a gap to the spacing lock 425 adjacent in the forward direction may be smaller than a gap between the spacing locks 425. That is, a center line in the forward-rearward direction of the third lock 421c is spaced apart forward by as much as a certain gap (g) from the reference position (o), therefore, the third lock 421c can support the inner forward surface of the locking hole 120 and support the lower rail 100 on the forward side.

Referring to FIGS. 7, 8d and 9b, the fourth lock 421d is disposed to lean to the rearward side by as much as a certain gap (g), and a gap to the spacing lock 425 adjacent in the rearward direction may be smaller than a gap between the spacing locks 425. That is, a center line in the forward-rearward direction of the fourth lock 421d is spaced apart rearward by as much as a certain gap (g) from the reference position (o), therefore, the fourth lock 421d can support the inner rearward surface of the locking hole 120 and support the lower rail 100 on the rearward side.

The first lock 421a, the second lock 421b, the third lock 421c, and the fourth lock 421d are asymmetrically disposed in a left-right direction on the plate body 410 and are asymmetrically disposed in the forward-rearward direction so that each thereof can support the load which is evenly distributed.

In more detail, in the locking plate 400, when the first lock 421a is disposed on one side in the left-right direction of the plate body 410, the second lock 421b is disposed on another side in the left-right direction of the plate body 410. In addition, in the locking plate 400, when the third lock 421c is disposed on one side in the left-right direction of the plate body 410, the fourth lock 421d is disposed on another side in the left-right direction of the plate body 410.

In addition, in the locking plate 400, the first lock 421a and the fourth lock 421d may be disposed on one side in the left-right direction, and the second lock 421b and the third lock 421c may be disposed on another side in the left-right direction. For example, as illustrated in the drawing, the first lock 421a and the fourth lock 421d may be disposed in the right end of the plate body 410, and the second lock 421b and the third lock 421c may be disposed in the left end of the plate body 410.

Therefore, the locking plate 400 may be fitted in and fastened to all of the inner forward surface and the inner rearward surface of the locking hole 120 and the inner forward surface and the inner rearward surface of the inserting hole 220. Accordingly, the locking plate 400 can minimize a clearance and a flow in the forward-rearward direction with the lower rail 100 and the upper rail 200, and can prevent a rotational flow.

However, the first lock 421a and the second lock 421b may lean to the forward side or the rearward side, and the third lock 421c and the fourth lock 421d may have the stepped shape.

In addition, each of the first lock 421a, the second lock 421b, the third lock 421c, and the fourth lock 421d may support one among the inner forward surface and the inner rearward surface of the locking hole 120, and the inner forward surface and the inner rearward surface of the inserting hole 220. To this end, the first lock 421a, the second lock 421b, the third lock 421c, and the fourth lock 421d may have the stepped shape on the supporting surface, or may lean to an object subjected to be supported. Further, the width of the inserting hole 220 in a forward-rearward direction may be smaller than the width of the locking hole 120 in a forward-rearward direction, and as the support lock 421 is spaced apart from the reference position by as much as a certain gap in a forward direction or a rearward direction, the support lock 421 can support the upper rail 200.

The present disclosure has been described in detail with reference to the exemplary embodiments, but the exemplary embodiments are illustrative and the present disclosure is not limited thereto. It is apparent that those skilled in the art may modify or improve the exemplary embodiments within the technical spirit of the present disclosure.

All of the simple modifications or changes of the present disclosure belong to the scope of the present disclosure, and the specific scope of the present disclosure may be apparent by the accompanying claims.

REFERENCE NUMERALS

| | |
|---|---|
| 10: seat rail | |
| 100: lower rail | 120: locking hole |
| 200: upper rail | 220: inserting hole |
| 300: locking unit | 400: locking plate |
| 410: plate body | 420: locking protrusion |
| 421: support lock | 421a: first lock |
| 421b: second lock | 421c: third lock |
| 421d: fourth lock | 423: protrusion |
| 425: spacing lock | |

What is claimed is:

1. A seat rail, comprising:
a lower rail installed on a bottom surface of a vehicle body and having a plurality of locking holes;
an upper rail fastened to a cushion frame of a seat, configured to move along the lower rail and having a plurality of inserting holes; and
a locking unit having a locking plate provided in the upper rail and selectively fastened to the lower rail, and configured to fix a position of the upper rail with respect to the lower rail,
wherein the locking plate includes:
a plate body; and
a plurality of locking protrusions provided in the plate body, inserted into and fixed to the inserting hole, and selectively fastened to the locking hole, and
wherein the locking protrusion includes a support lock supporting one among the upper rail and the lower rail, and having one contact point supporting the upper rail or the lower rail.

2. The seat rail of claim 1,
wherein the support lock is in contact with one among an inner forward surface and an inner rearward surface of the inserting hole and is spaced apart from another one thereamong, or, is in contact with one among an inner forward surface and an inner rearward surface of the locking hole and is spaced apart from another one thereamong.

3. The seat rail of claim 2,
wherein the support lock includes a protrusion stepped and protruding from one surface on which the contact point is provided, and supporting the upper rail or the lower rail.

4. The seat rail of claim 2,
wherein a width of the locking hole in a forward-rearward direction is smaller than a width of the inserting hole in a forward-rearward direction, and
wherein the support lock is spaced apart forward or rearward from a center of the locking hole by as much as a pre-determined gap and supports the lower rail.

5. The seat rail of claim 2,
wherein a width of the inserting hole in a forward-rearward direction is smaller than a width of the locking hole in a forward-rearward direction, and
wherein the support lock is spaced apart forward or rearward from a center of the inserting hole by as much as a pre-determined gap and supports the upper rail.

6. The seat rail of claim 1,
wherein the support lock includes;
a first lock supported on an inner forward surface of the inserting hole;
a second lock supported on inner reward surface of the inserting hole;
a third lock supported on an inner forward surface of the locking hole; and
a fourth lock supported on inner reward surface of the locking hole.

7. The seat rail of claim 6,
wherein in the locking plate, when the first lock is disposed on one side in a left-right direction of the plate body, the second lock is disposed on another side in a left-right direction of the plate body, and when the third lock is disposed on one side in a left-right direction of the plate body, the fourth lock is disposed on another side in a left-right direction of the plate body.

8. The seat rail of claim 6,
wherein in the locking plate, the first lock and the fourth lock are disposed on one side in a left-right direction of the plate body, and the second lock and the third lock are disposed on another side in a left-right direction of the plate body.

9. The seat rail of claim 1,
wherein the locking protrusion further includes:
a plurality of spacing locks inserted into the inserting hole and the locking hole and inserted thereinto with a gap in a forward-rearward direction.

10. The seat rail of claim 1,
wherein the upper rail has the inserting hole opened downward and is provided such that an inner forward surface and an inner rearward surface thereof are inclined, and a width thereof in a forward-rearward direction becomes greater toward a lower side, and
wherein the lower rail has the locking hole opened downward and is provided such that an inner forward surface and an inner rearward surface thereof are inclined, and a width thereof in a forward-rearward direction becomes greater toward a lower side.
